(19) United States
(12) Patent Application Publication
(10) Pub. No.: US 2003/0175377 A1
(43) Pub. Date: Sep. 18, 2003

(54) Roller apparatus for control of building block dimensions during manufacture

(76) Inventor: John H. Guy, Houston, TX (US)

Correspondence Address: ONEBANE, BERNARD, TORIAN, DIAZ, MCNAMARA & ABELL, P. O. BOX 3507, LAFAYETTE, LA, 70502, US

(21) Appl. No.: 10/033,659

(22) Filed: Dec. 28, 2001

(51) Int. Cl. B28B 3/12

(52) U.S. Cl. 425/363; 425/385; 264/284

(57) ABSTRACT

Apparatus and method for control of dimensions of formed building blocks during manufacture. A frame forms an opening, through which runs a conveyor carrying the blocks. An elongated, horizontally-aligned roller is positioned a desired distance above the conveyor surface. While the blocks are still in a “wet” or uncured state, and therefore relatively malleable, they are carried through the opening and pass beneath the horizontal roller, which deforms or “squeezes” the blocks down to the precise desired vertical dimension.

### BACKGROUND

1. Field of Art

This invention relates to apparatus used in the manufacture and production of building blocks, particularly those formed from aggregates such as concrete and the like. With more particularity, the present invention relates to a device for precise dimensional control, in particular the height of aggregate building blocks, by use of a roller mechanism.

2. Related Art

Building blocks made of aggregates, such as concrete, are used in the manufacture of many different types of buildings. In contrast to wood construction, building blocks possess the advantages of high strength, and are unaffected by rot, termites, and the like. In addition to use in commercial buildings, building block construction of residential dwellings is becoming more common. In particular, residential construction using building blocks is becoming increasingly considered for areas where natural phenomena such as earthquakes and hurricanes require high quality construction.

Relatively precise dimensional control is important for building blocks used in certain building methods, in particular use of such blocks in “dry stack” procedures. In order for that method to be efficiently used, the dimensions of each block must be very uniform. A problem arises in the typical block forming procedure, whereby the extrusion or molding process does not result in blocks having sufficiently precise (that is, conformance to a particular desired value, such as height) and uniform (that is, each block being of substantially the same height) dimensions. By way of example, the control of the height of the block as to both conformance to a desired dimension and uniformity between blocks is very important. Similar concerns and requirements exist as to the length and height of the blocks, but due to the molding method such dimensions are generally controlled by the mold dimensions. The height dimension, however, is not as precisely controllable during the molding operation, hence another means of controlling height is required. One method used in the past to make the critical dimensions of building blocks both precise and uniform has been to grind the finished blocks (after the blocks have cured to a final, hardened state) to the desired dimensions. This procedure is costly and time consuming.

The present invention enables dimensional control of the blocks while the blocks are still in a plastic or malleable state, before final curing and hardening. More specifically, the present invention is an apparatus having one or more rollers which precisely control the height dimension of the blocks, by forming an opening of a known, adjustable dimension, then passing the blocks through that opening while the blocks are in a plastic or malleable state. The blocks, to the extent that they may be oversize, are in effect “squeezed down” to the desired dimensions. Once the dimensions are corrected, the blocks then are cured to form a hardened building block having precise and uniform dimensions.

### SUMMARY OF THE INVENTION

The present invention is an apparatus comprising a frame having an opening and at least one elongated roller mounted therein, the rotational axis of the roller being substantially horizontal (a “horizontal roller”). A roller table or conveyor is cooperatively adapted so as to permit building blocks to be carried on a steel pallet on the roller table, beneath the horizontal roller which is placed at a desired vertical dimension defined as the distance between the pallet surface and the bottom edge of the horizontal roller. The horizontal roller is powered so as to turn at the same speed as the blocks progress beneath it. In addition, the horizontal roller may be heated and/or formed with a non-stick surface, both of which tend to lessen the tendency of the wet aggregate to stick to the roller surface.

### BRIEF DESCRIPTION OF THE DRAWINGS

FIG. 1 is a schematic of a formed building block showing the dimensions thereof referred to as “height,” “length,” and “width.”

FIG. 2 is a front view of an embodiment of the apparatus.

FIG. 3 is a side view of the apparatus shown in FIG. 2.

### DETAILED DESCRIPTION OF THE PRESENTLY PREFERRED EMBODIMENT

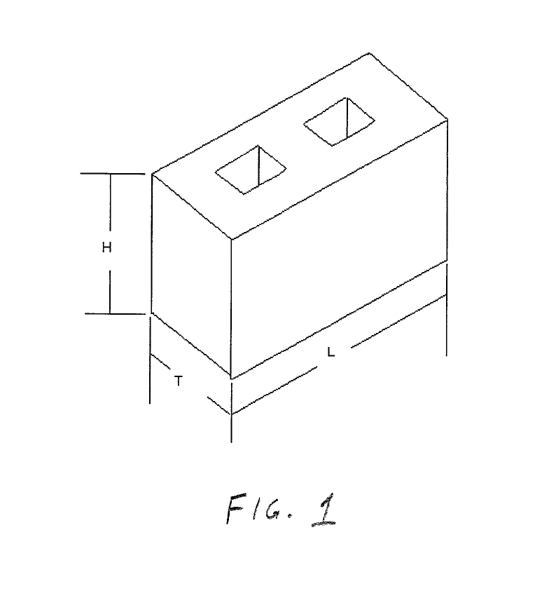

For purposes of this description, it is useful to define the terms “height,” “length,” and “thickness” as such terms are used herein. FIG. 1 shows a perspective view of a building block, with the height thereof shown as dimension “H,” the length as dimension “L,” and the thickness as dimension “T.”

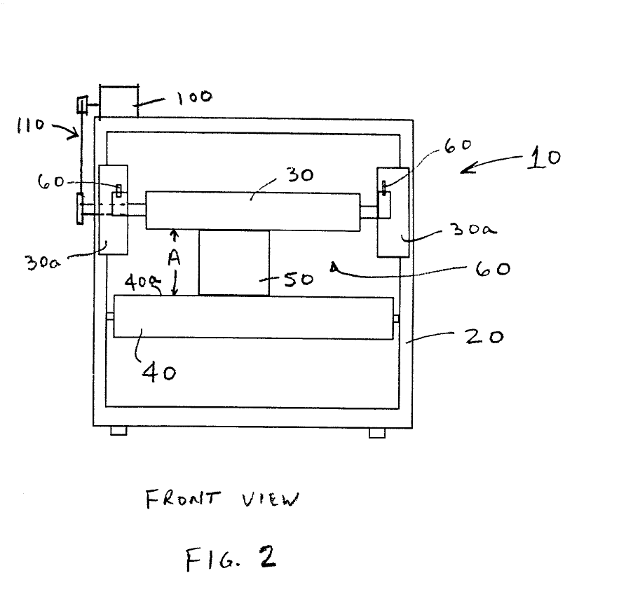

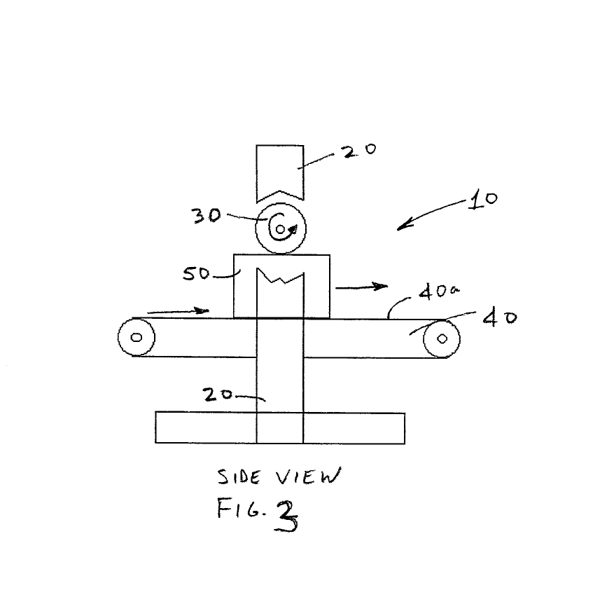

While many variations of the apparatus and method could be made, while still falling within the scope of the appended claims, the following description sets forth one present preferred embodiment. With reference to FIGS. 2 and 3, the apparatus 10 comprises a frame 20 having at least one elongated horizontal roller 30 mounted thereon. FIG. 2 is a front view of apparatus 10, while FIG. 3 is a side view with frame 20 in partial cross section. As can be seen, horizontal roller 30 is disposed with its rotational axis substantially horizontal. A conveyor 40, which may be a conveyor belt, a set of rollers, or a solid (that is, non-moving) surface, is cooperatively adapted so as to permit blocks 50 to be carried through an opening 60 having a vertical dimension A defined by the conveying surface 40a and the lowermost edge of horizontal roller 30. Blocks 50 may also be carried on a pallet, which is in turn carried on conveyor 40, in which case dimension A represents the distance between the surface of the pallet and the lowermost edge of horizontal roller 30. Although FIGS. 2 and 3 illustrate only a single block 50, it is understood that more than one block (for example, four blocks at a time) may be grouped together for passage beneath the horizontal roller or rollers.

While apparatus 10 as shown in FIGS. 2 and 3 has only a single horizontal roller 30, placed so as to control a height of block 50, it is understood that additional horizontal rollers 30 could be placed in a spaced-apart position, each of said rollers disposed substantially parallel with one another, so as to provide multiple horizontal roller surfaces to contact blocks 50.

The height of horizontal roller 30 above conveyor surface 40a may be grossly adjusted by changing placement of roller carriage 30a (carrying horizontal roller 30) on frame 20, via multiple mounting bolt holes or other like means. Once the desired gross placement is satisfactory, finer adjustment may be made via lead screws 60 which move horizontal roller 30 upwardly or downwardly with respect to roller carriage 30a.

To use apparatus 10 for control of the vertical dimension of aggregate building blocks, by deforming or “squeezing down” the blocks to a desired dimension, at least one block 50 is provided which has been formed of an aggregate or concrete, either by a molding or extrusion process. While block 50 is still in a plastic or “wet” state (that is, the aggregate comprising block 50 is sufficiently stiff that block 50 substantially retains its formed shape, but is not yet “cured”, therefor may still be manipulated into a desired shape), block 50 is carried on conveyor 40 through opening 60, which is bounded on the top by horizontal roller 30. Typically, the height of block 50 is relatively close to the final, desired dimension, but is slightly oversize. Horizontal roller 30, in the preferred embodiment, is driven by an electric motor 100 or other rotary power means well known in the art (such as a hydraulic motor), coupled to horizontal roller 30 via a coupling means 110, which may comprise a pair of pulleys and a connecting belt or chain. The rotational surface speed of horizontal roller 30 is substantially equal to the linear speed of block 50 as it passes beneath horizontal roller 30. Block 50 then passes under horizontal roller 30, thereby deforming or “squeezing down” the height of block 50 to the desired vertical or height dimension.

In addition, the invention may comprise a means for heating the surface of roller 30, which may be electric resistance coils or other means well known in the art, to reduce instances of the aggregate “sticking” to roller 30. Roller 30 may also be made of or coated with materials likely to avoid sticking of the aggregate to the roller, such as plastics, highly polished metals, or the like.

Although the preceding description sets forth many specificities, such specificities are by way of example only and do not limit the scope of the invention. For example, the invention may have more than one roller to control a given dimension (that is, the block would pass beneath or between two or more rollers, each of which controlling a given dimension). In addition to placement of roller or rollers to control the height of building blocks, rollers can also be placed in a substantially vertical orientation to control length and width. The apparatus can be dimensioned so as to pass more than one block through the roller system at any one time.

Thus, the scope of the invention is to be measured by the appended claims and their legal equivalents.

I claim:

1. An apparatus for dimensional control of formed building blocks, while said building blocks are in a malleable state, comprising:
a) a frame having an opening therein;
b) a conveyor positioned within said opening and adapted to carry building blocks through said opening; and
c) at least one elongated, rotatable horizontal roller mounted to said frame at a desired distance above said conveyor,
whereby when said building blocks are carried on said conveyor beneath said horizontal roller, said horizontal roller deforms a height of said building blocks to a dimension equal to the distance between a lowermost edge of said horizontal roller and the surface supporting said building blocks.

2. The apparatus of claim 1, further comprising a rotary power means operatively coupled to said horizontal roller, for rotating said horizontal roller at a surface rotational speed substantially equal to a linear speed of said building blocks.

3. The apparatus of claim 2, wherein said rotary power means is an electric motor.

4. The apparatus of claim 2, further comprising a means for heating an outer surface of said horizontal roller.

5. The apparatus of claim 2, wherein an outer surface of said horizontal roller comprises a material resistant to adhering to said building block.

6. The apparatus of claim 3, further comprising a means for heating an outer surface of said horizontal roller.

7. The apparatus of claim 2, further comprising a carriage supporting said horizontal roller, and a lead screw operatively coupled to said carriage and said horizontal roller for adjusting the position of said horizontal roller with respect to said carriage.

8. An apparatus for deforming formed building blocks, while said building blocks are in a malleable state, to yield desired dimensions, comprising:
a) a frame having an opening therein;
b) a conveyor positioned within said opening and adapted to carry building blocks through said opening; and
c) at least one elongated, rotatable horizontal roller mounted on a carriage, said carriage coupled to said frame, and a lead screw operatively coupled to said carriage and said horizontal roller for adjusting the position of said horizontal roller with respect to said carriage, thereby placing said horizontal roller at a desired distance above said conveyor;
d) a rotary power means operatively coupled to said horizontal roller, for rotating said horizontal roller at a surface rotational speed substantially equal to a linear speed of said building blocks,
whereby when said building blocks are carried on said conveyor beneath said horizontal roller, said horizontal roller deforms a height of said building blocks to a dimension equal to the distance between a lowermost edge of said horizontal roller and the surface supporting said building blocks.

9. The apparatus of claim 8, further comprising a means for heating an outer surface of said horizontal roller.

10. A method of precise dimensional control of formed building blocks, comprising the steps of:
a) providing an apparatus comprising:
i) a frame having an opening therein;
ii) a conveyor positioned within said opening and adapted to carry building blocks through said opening; and
iii) at least one elongated, rotatable horizontal roller mounted to said frame at a desired distance above said conveyor,
whereby when said building blocks are carried on said conveyor beneath said horizontal roller, said horizontal roller deforms a height of said building blocks to a dimension equal to the distance between a lowermost edge of said horizontal roller and the surface supporting said building blocks; and
b) passing one or more building blocks while said building blocks are in a malleable state between said roller and said conveyor surface, whereby a vertical dimension of said building blocks is deformed to a desired dimension.
